(19) United States
(12) Patent Application Publication
(10) Pub. No.: US 2014/0203961 A1
(43) Pub. Date: Jul. 24, 2014

(54) Debris Examination Using Ballistic and Radar Integrated Software

(71) Applicants: Brian M. Kent, Dayton, OH (US); Anthony D. Griffith, SR., Houston, TX (US); Christopher G. Thomas, Fairborn, OH (US); Jonathan W. Benson, Beavercreek, OH (US); Matthew L. Schottel, Seabrook, TX (US); David E. Lee, Houston, TX (US); Joseph A. Hamilton, Friendswood, TX (US)

(72) Inventors: Brian M. Kent, Dayton, OH (US); Anthony D. Griffith, SR., Houston, TX (US); Christopher G. Thomas, Fairborn, OH (US); Jonathan W. Benson, Beavercreek, OH (US); Matthew L. Schottel, Seabrook, TX (US); David E. Lee, Houston, TX (US); Joseph A. Hamilton, Friendswood, TX (US)

(21) Appl. No.: 13/740,629

(22) Filed: Jan. 14, 2013

(51) Int. Cl. G01S 13/95

(52) U.S. Cl. CPC G01S 13/95
USPC 342/26 D

(57) ABSTRACT

A method is provided for analyzing debris events after a launch of a rocket-propelled vehicle. Radar and Doppler data of the launch of the rocket-powered vehicle is collected for a period of time. Atmospheric conditions are determined at the time of launch. A trajectory of the rocket-propelled vehicle is determined during ascent. The collected radar and Doppler data is aligned and calibrated. A first portion of the collected radar and Doppler data is processed with a first means for assessing and characterizing debris. In parallel with the first portion of the collected radar and Doppler data, a second portion of the collected radar and Doppler data is processed with a second means for assessing and characterizing debris. Assessed and characterized debris is identified that may be a threat to the vehicle. And, reports of the identified debris are generated.

### RIGHTS OF THE GOVERNMENT

The invention described herein may be manufactured and used by or for the Government of the United States for all governmental purposes without the payment of any royalty.

### FIELD OF THE INVENTION

The present invention generally relates to radar data analysis and, more particularly, analysis of critical attributes of debris released from an ascending launch vehicle.

### BACKGROUND OF THE INVENTION

The Space Shuttle Columbia disaster occurred on Feb. 1, 2003, when shortly before it was scheduled to conclude its 28th mission, STS-107, the Space Shuttle Columbia disintegrated over Texas and Louisiana during re-entry into the Earth's atmosphere, resulting in the death of all seven crew members. Debris from Columbia fell to Earth in Texas along a path stretching from Trophy Club to Tyler, as well as into parts of Louisiana.

The loss of Columbia was a result of damage sustained during launch when a piece of foam insulation the size of a small briefcase broke off from the Space Shuttle main propellant external tank under the aerodynamic forces of launch. The debris struck the leading edge of the left wing, damaging the Shuttle's thermal protection system, which shields it from the intense heat generated from atmospheric friction during re-entry. During the ascent phase, NASA's Space Shuttle is known to generate and liberate debris in flight. Most of the debris is completely nominal, and is comprised of solid rocket booster (SRB) exhaust products (“slag”), and Orbiter main engine H₂O exhaust products. However, certain “unintentional” debris is occasionally liberated from the shuttle during ascent. As part of the post-Columbia “return to flight” (RTF) activities, NASA's Ascent Debris Radar Working Group (ADRWG) analyzed all phases of the Shuttle ascent to determine what debris generation posed a potential threat to the Shuttle elements, with the intent to eliminate all known unintentional debris sources. Historically, low-resolution FPQ-14 ground radar cross section (RCS) data showed a significant bloom in radar signature between 120-130 seconds after launch shortly after the booster separation motors (BSM) are fired. A candidate cause for this large RCS increase at booster separation is the combined particulate smoke plumes generated by the simultaneous firing of sixteen BSM rockets.

There are generally two phases of motor firing that are of interest to NASA. During the BSM firing itself (lasting approximately 0.8 seconds), the propellant is rapidly consumed to produce nearly 20 Klbs of sustained thrust from each of the 16 motors. During the firing, the BSMs also produce aluminum oxide exhaust products in the amount of 2% by weight. The post firing, exhaust smoke plume is dominated by residual Al₂O₃, which dissipates slowly at 160,000 ft altitude, but fairly rapidly at static sea level. In the low density of the upper atmosphere, it is believed that this BSM plume residue acts like a cloud of metallic particles, similar to a “chaff cloud”. By proving that the post SRB signature growth was caused by nominal BSM motor firings, NASA could confidently state that this temporary increase in Shuttle signature was routine and posed no unexpected safety threat to the crew or mission.

During the STS-107 accident investigation, radar data collected during ascent indicated a debris event that was initially theorized to be the root cause of the accident. This theory was investigated and subsequently disproved by the Columbia Accident Investigation Board (CAIB). However, the data itself and the lack of understanding of what debris data in radar meant to the shuttle program, required further analysis and understanding.

The Space Shuttle Program Systems Engineering and Integration (SE&I) Office commissioned the ADRWG to characterize the debris environment during a Space Shuttle launch and to identify/define the return signals as seen by radar. Once the capabilities and limitations of the existing radars for debris tracking were understood, the team researched proposed upgrades to the location, characteristics, and post-processing techniques needed to provide improved radar imaging of Shuttle debris.

The research phase involved in assessing the threat ultimately evolved into an inter-agency cooperation between NASA and the Navy for shared use of radar assets to the benefit of both agencies. Additional cooperative agreements were made with the Air Force and Army regarding various support aspects to the debris radar efforts. An aggressive schedule of field testing preceded the initial operations of the system during the STS-114 Return to Flight (RTF) mission.

A development and facilities plan was built that allowed simultaneous construction, system development, and operations of the radars from the same site. As operational experience was gained, the debris assessment capabilities of the NASA Debris Radar (NDR) team improved through this development phase. The construction was completed and the NDR team turned to full operations.

During the STS-107 accident investigation, Air Force Research Laboratory (AFRL) was assigned to investigate the mysterious separation of a piece of orbital debris from the orbiter Columbia on Flight Day 2. AFRL obtained two pieces of information regarding the on-orbit debris event. NASA determined the object's mass to area ratio to within 15% based on its 60-hour deorbiting curves and the USAF's UHF tracking radar at Cape Cod measured the object's radar cross section bounds from on-orbit observations taken during the STS-107 mission. Based on these two pieces of information (mass to area ratio and UHF RCS variations), AFRL subsequently tested 31 samples of materials that comprised the exterior of the Shuttle Orbiter and the interior of Shuttle payload bay. The results of these tests, when combined with forensic analysis of recovered debris, concluded with very high probability that the mysterious “on-orbit” flight day two piece was likely approximately a 120 in² piece of damaged carbon-carbon leading edge from the left wing of the Shuttle.

The fact that ground radar could easily track a 120 in² piece of shuttle debris in low earth orbit prompted NASA to investigate the use of radar for subsequent pre-orbital ascent debris liberation assessments and potentially for on-orbit mission monitoring. However, radar alone was determined to be insufficient for tracking and fully analyzing debris resulting from launch.

It should be noted that all rocket-propelled launch vehicles release both expected and unexpected debris during the course of nominal operations. Accordingly, there is a need in the art for an efficient methodology to identify and track debris events during the initial period after launch.

### SUMMARY OF THE INVENTION

Embodiments of the invention provide a method for analyzing debris events after a vehicle launch. Radar and Doppler data of the launch event is collected for a period of time. Atmospheric conditions are determined at the time of launch. A trajectory of the vehicle is determined during ascent. The collected radar and Doppler data is aligned and calibrated. A first portion of the collected radar and Doppler data is processed with a first means for assessing and characterizing debris. In parallel with the first portion of the collected radar and Doppler data, a second portion of the collected radar and Doppler data is processed with a second means for assessing and characterizing debris. Assessed and characterized debris is identified that may be a threat to the vehicle.

Embodiments of the invention further post-process the processed first and second portions of the collected radar and Doppler data to visualize vehicle and debris trajectories and estimate release locations of debris. In some embodiments, the post-processing of the processed first and second portions of the collected radar and Doppler data includes a data transformation, which adaptively scales the processed first and second portions of the collected radar and Doppler data to a statistical distribution of noise to be approximately constant across the data to identify weak debris signatures.

In other embodiments, the post-processing of the processed first and second portions of the collected radar and Doppler data may include generating nomographs from the processed first and second portions of the collected radar and Doppler data. In some of these embodiments, the generated nomographs may include material class via ballistic number and RCS values, ballistic number versus RCS, characteristic size versus RCS, RCS versus X-band radar, RCS versus C-Band radar and combinations thereof.

In some embodiments, the post-processing of the processed first and second portions of the collected radar and Doppler data may include displaying on a computer display a position of a trajectory of the rocket-propelled vehicle overlaid on corresponding collected radar and Doppler data.

Some embodiments, the second means for assessing and characterizing debris may utilize a Multi-Scale Localized Radon Transform (MSLRT) to analyze the second portion of the collected radar and Doppler data. In some embodiments, the first means for assessing and characterizing debris may provide a confidence level that an assessed radar track is a physical object rather than noise that appears to represent a real object. In these embodiments, the provided confidence of first means for assessing and characterizing debris may be determined using metrics including a Kolmogorov-Smirnov (K-S) statistic.

In some embodiments, the first and second means for assessing and characterizing debris may include a calculation of a ballistic number. In other embodiments, after the first means assesses and characterizes debris, a separate trajectory may be analyzed utilizing day-of-launch inputs to develop a free-stream ballistic debris trajectory model. In these embodiments, day-of-launch inputs may include weather, launch time, vehicle trajectory, radar position, and combinations thereof.

Additional objects, advantages, and novel features of the invention will be set forth in part in the description which follows, and in part will become apparent to those skilled in the art upon examination of the following or may be leaned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is Radar System Geometry for ISS Launch;

FIG. 2 is NDR Observation Strategy;

FIG. 3 is Forces Acting on the Shuttle and Debris Objects;

FIG. 4 is Calculated RTI Plot of the SSV;

FIG. 5 is Foam Mounted for Measurement in the ACR;

FIG. 6 is Plot of Foam RCS vs Azimuth;

FIG. 7 is Shuttle Debris Ballistic Number vs. RCS Zone Definitions;

FIG. 8 is a nomograph of RCS and BN for four categories of debris;

FIG. 9 is a nomograph of BN vs. RCS;

FIG. 10 is a plot of RCS vs. size for C-band Radar;

FIG. 11 is a plot of RCS vs. size for X-band Radar;

FIGS. 12A-12D are Doppler Time Intensity Plots from Dynamic Measurements;

FIG. 13 is ARDENT showing detected debris tracks during launch;

FIG. 14 is a block diagram of a debris analysis tool used to analyze debris in the first 150 seconds;

FIG. 15 is Fusion Tool display of SSV trajectory and NDR pointing directions;

FIG. 16 is a display of SSV overlaying Radar data;

FIG. 17 is a system diagram of the debris analysis system used in embodiments of the invention; and

FIG. 18 is an exemplary hardware and software system for use with embodiments of the invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

During the Space Shuttle Columbia STS-107 accident investigation, radar data collected during ascent indicated a debris event that was initially theorized to be the root cause of the accident. This theory was investigated and subsequently disproved by a Columbia Accident Investigation Board (CAIB). However, the data itself and the lack of understanding of what debris data in radar meant to the shuttle program, required further analysis and understanding.

The Space Shuttle Program Systems Engineering and Integration Office commissioned an Ascent Debris Radar Working Group (ADRWG) to characterize the debris environment during a Space Shuttle launch and to identify/define the return signals as seen by radar. Once the capabilities and limitations of the existing radars for debris tracking were understood, the team researched proposed upgrades to the location, characteristics, and post-processing techniques needed to provide improved radar imaging of Shuttle debris.

The research phase involved in assessing the threat ultimately evolved into an inter-agency cooperation between NASA and the Navy for shared use of a C-band radar asset to the benefit of both agencies. In addition, two X-band Doppler radars were procured. Additional cooperative agreements were made with the Air Force and Army regarding various support aspects to the debris radar efforts. A development and facilities plan was built that allowed simultaneous construction, system development, and operations of the radars from the same site. As operational experience was gained, the debris assessment capabilities of the NASA Debris Radar (NDR) team improved through this development phase. The construction was completed and the NDR team turned to full operations by the end of calendar year 2008.

While initial NDR missions proved the extent of the debris detection and tracking challenge, improvements in NDR hardware, software, and mission operations resulted in very successful debris detection and tracking. These successes lead to a new challenge of processing and analyzing the large amount of radar data collected by the NDR systems and extracting information useful to the NASA debris community in a short amount of time. To assist in meeting this challenge, analysis tools and software codes utilized by embodiments of the invention assist in visualizing the shuttle metric data in real-time, visualizing metric and signature data during post-mission analysis, automatically detecting and characterizing debris tracks in signature data, determining ballistic numbers for detected debris objects, and assessing material type, size, release location and threat to the orbiter based on radar scattering and ballistic properties of the debris.

A number of factors directed the radar selection. The radars had to be sensitive enough to detect the expected debris. The radar systems needed to discriminate the debris in both spatial and velocity domains to increase the probability of detection and characterize the debris location, source and type. The radars also had to be positioned to allow continuous, unobstructed coverage of the vehicle during ascent, specifically during the Aerodynamically Sensitive Threat Time (ASTT) of the trajectory, which is approximately 40 to 150 seconds after launch. It should be noted that all rocket-propelled launch vehicles release both expected and unexpected debris during the course of nominal operations. The unique aspect of the shuttle missions, including a human crew, required a higher level of insight and therefore more probative capability for assessing the debris threats to the crew and vehicle. While the illustrated embodiment focuses on shuttle missions, the embodiments of the invention may also be used for similar analysis of debris from unmanned launch vehicles as well.

A wideband, high resolution C-band pulsed radar was selected to fulfill the requirement to detect and resolve small debris items that are released very close to the ascending Space Shuttle Vehicle (SSV) structure 10, though other radars were also contemplated. The pulsed radar facilitates precise determination of debris location information relative to the SSV structure. In addition, X-band Continuous Wave (CW) Doppler radars were required to capture the precise velocity profile (deceleration) of a liberated debris piece in a continuous, instantaneous, and unambiguous manner. The two different types of radar systems are highly complementary and their fused output presents a near complete time, position, and velocity profile for liberated debris pieces.

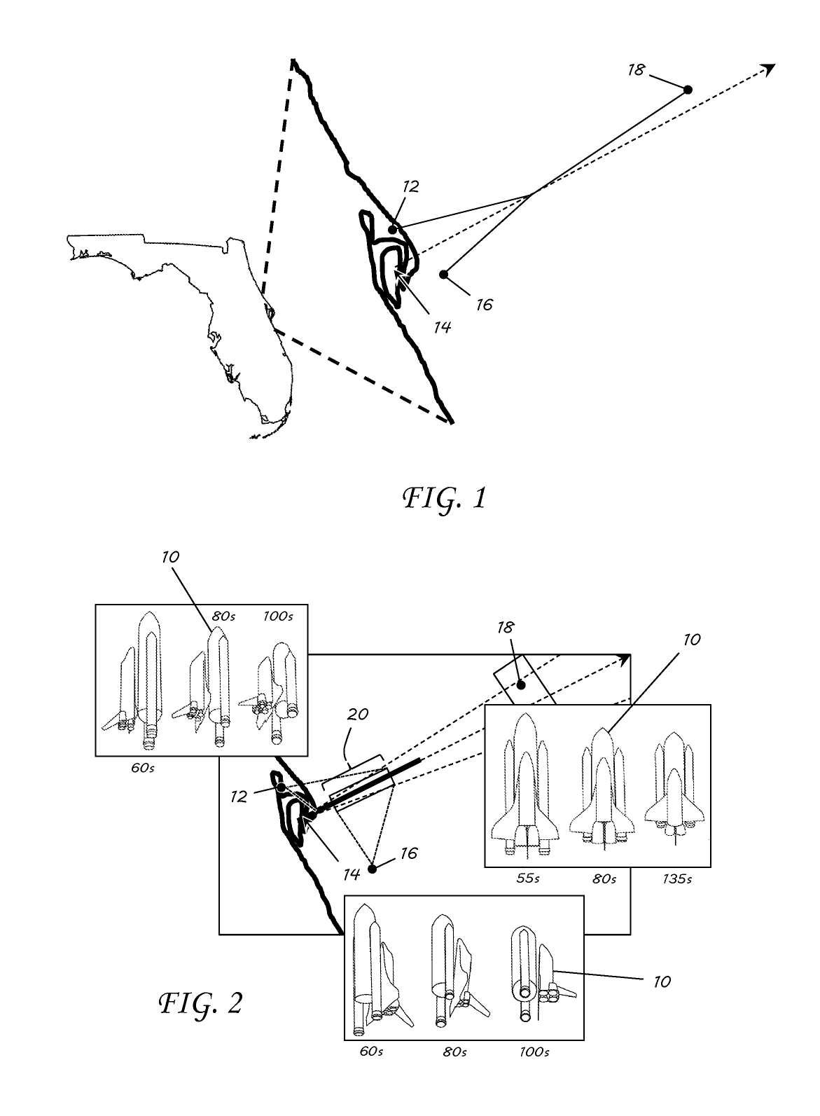

A Mid-Course Radar 12 was installed approximately 12 miles north of the SSV launch pads 14. In addition, two mobile, ship based, CW Doppler radars 16, 18 were acquired to complete the geometric coverage of the SSV during ASTT 20 portion of ascent. FIG. 1 shows the geometry of the NDR radar systems during an SSV ascent. FIG. 2 illustrates the combined radar observation strategy of the NDR systems. As shown in the FIG. 2, the left, right, forward, and aft sections of the SSV 10 is under observation during ascent, specifically during the ASTT portion 20 of the trajectory. The downrange (NASA SRB recovery ship based) Doppler system 18 provides critical coverage of wing leading edge and debris liberation from high in the stack. Additionally, FIG. 2 illustrates the orientation of the SSV 10 relative to each of the radar locations 12, 16, 18 at different time intervals.

The NDR systems successfully identified and characterized ascent debris from several missions, with results that have been corroborated with data from optical sensors. The solid rocket boosters are tracked each shuttle launch from separation through water impact, and various parameters are assessed such as separation velocity and tumble period.

The radar data collected each mission provides direct insight into the ballistic properties of debris objects visible to the radar. A method for determining the ballistic number (BN) from the radar data is defined according to the following equation:

$$BN = \frac{Weight}{{C}_{D} * A} \qquad ( 1 )$$

In this equation, C_{D} represents the drag coefficient of the debris object, and A reflects the surface area of the object. Together with dynamic pressure ( q̅), the BN determines an object's acceleration due to drag according to the following derivation:

$$\begin{matrix}\overline{q} = \frac{1}{2} * ρ * {V}_{rel\_wind}^{2} & ( 2 ) \\ {α}_{drag} = \frac{{F}_{drag}}{mass} = \frac{\overline{q} * {C}_{D} * A}{mass} = \frac{\overline{q} * {g}_{0}}{BN} & ( 3 )\end{matrix}$$

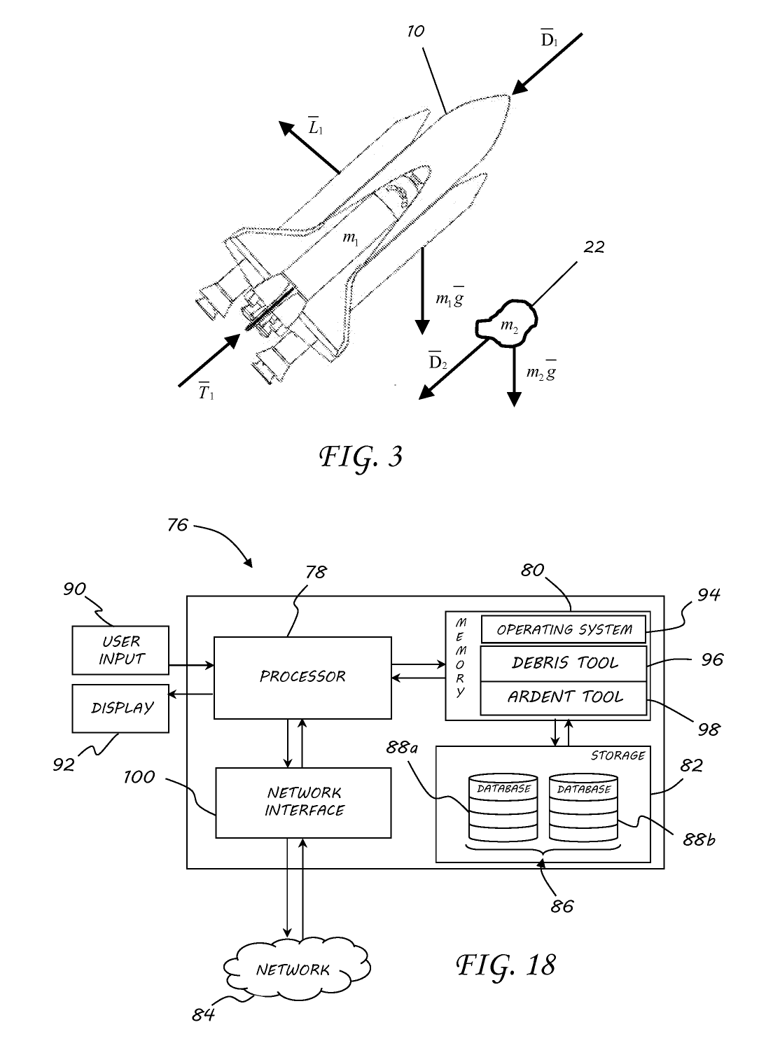

In this derivation, ρ is the atmospheric density, and Vᵣₑₗ_{_{—}}_{wind} is the object's velocity with respect to the atmosphere. In order to propagate an assumed ballistic trajectory, initial conditions are required. The only known state that can be utilized is the object being tracked by the radar; in this case, the SSV 10. FIG. 3 provides a simplified view of the situation, with the forces acting on the objects described. The SSV experiences forces due to thrust (T₁), lift (L₁), drag (D₁), and gravity (m₁g). A debris object 22 is assumed to experience only Drag (D₂) and gravity (m₂g).

To determine the acceleration force on the debris object 22, the difference in the forces acting on both objects results in the following equation when ballistic number is substituted:

$${\overline{a}}_{2} - {\overline{a}}_{1} = \overline{q} \frac{{C}_{D} A}{{m}_{2}} - \frac{{\overline{T}}_{1} + {\overline{D}}_{1} + {\overline{L}}_{1}}{{m}_{1}} = \overline{q} \frac{{g}_{0}}{BN} - \frac{{\overline{T}}_{1} + {\overline{D}}_{1} + {\overline{L}}_{1}}{{m}_{1}} \qquad ( 4 )$$

This derivation allows a relative trajectory profile to be propagated if the trajectory of the SSV 10 is known, along with the local atmospheric profile.

NDR ballistic number software allows a user to estimate a ballistic number, which is then used to calculate the debris object acceleration due to drag with knowledge of the atmospheric conditions at the time of release. From this point a trajectory can be propagated and displayed over the radar range or Doppler imagery. If the resultant trajectory does not fit the debris profile in the range or Doppler data, a user can adjust the ballistic number estimate to try to achieve a better fit.

A key limitation of the contemporary ballistic analysis process is the assumption that debris object motion occurs through a purely free-stream environment. Multiple regions exist where the atmospheric conditions are not free-stream, such as the boundary layer and shock zones around the SSV 10, as well as a recirculation region just aft of the SSV 10 main engines. Behind the vehicle, debris encounters the SSV 10 SRB plumes, as well as the wake effects of the SSV 10 stack.

All of this behavior should be accounted for when ballistic numbers are reported. If an object does not appear to have ballistic behavior, no specific numbers are reported. However, the lack of free-stream ballistic behavior in itself is valuable information. It may indicate that the debris object 22 is either within the SSV 10 stack when visible, or in the region just behind. These objects are considered a high priority for analysis.

Simulation of the SSV 10 radar signature is utilized in some embodiments to determine the NDR hardware and software settings that enabled optimal shuttle tracking and debris detection. Detailed SSV facet models consisting of over 1.2 million facets were used to simulate the coherent scattered field every 0.32 seconds of the flight during the periods of 0 to 302 seconds at 512 discrete frequencies in the band 5.45-5.95 GHz. The facet files contain fine features of the SSV 10 such as the circular rings on the nozzles, interconnection hardware, and reaction control system jets. Simulations were performed using XPATCH® Elecromagnetic Simulation Software produced by SAIC, Inc. of McLean, Va., though other similar simulation software may also be used.

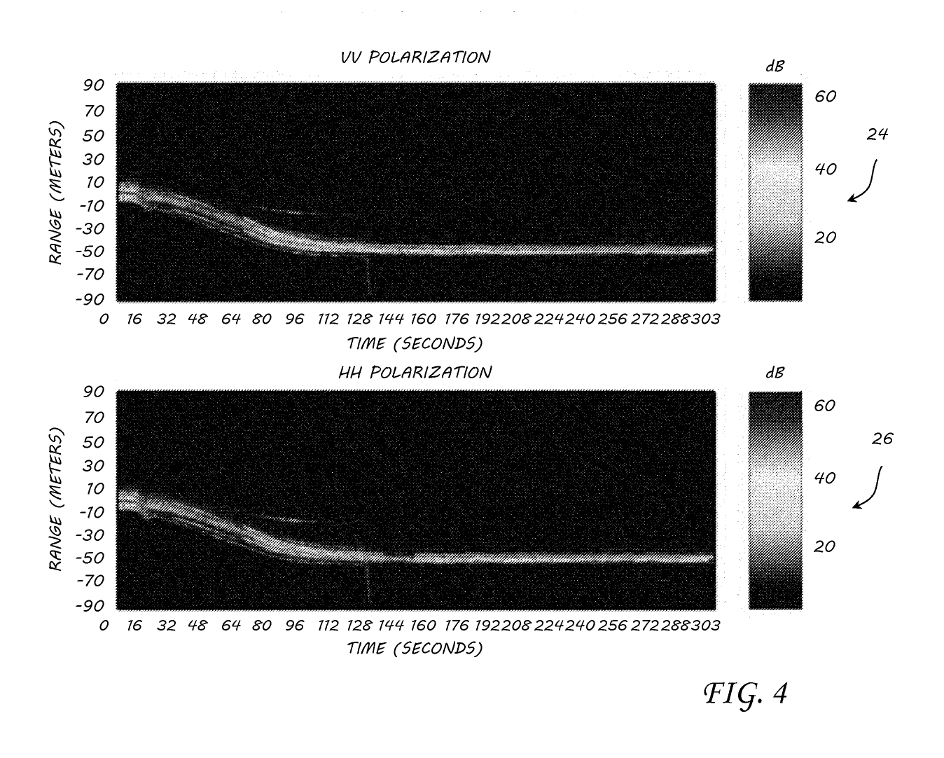

Combined frequency responses from the simulations are used to calculate Range-Time-Intensity (RTI) plots for the first 302 seconds of the mission. Similarly, calculations at two X-band frequencies are used to establish baseline shuttle signature levels. At each time step, corresponding elevation and azimuth angles viewed from the pilot seat to the radar are calculated and used in the XPATCH® simulations. For the C-band radar, each range profile of the SSV 10 for a particular aspect angle is constructed at each of the 512 frequencies. The number of discrete frequencies was chosen as such to adequately cover the SSV 10 span and multiple bounces, though other discrete frequencies may also be used. SRB separation was modeled at 124.48 seconds. Since there are 948 time steps in the time interval 0-302.72 seconds, 948 range profiles of the Shuttle are computed and stacked together to create RTI plots, such as plots 24 and 26 displayed in FIG. 4. This simulated data was used in some embodiments to determine radar settings, such as power level and receive gate positioning, as a function of the SSV 10 trajectory.

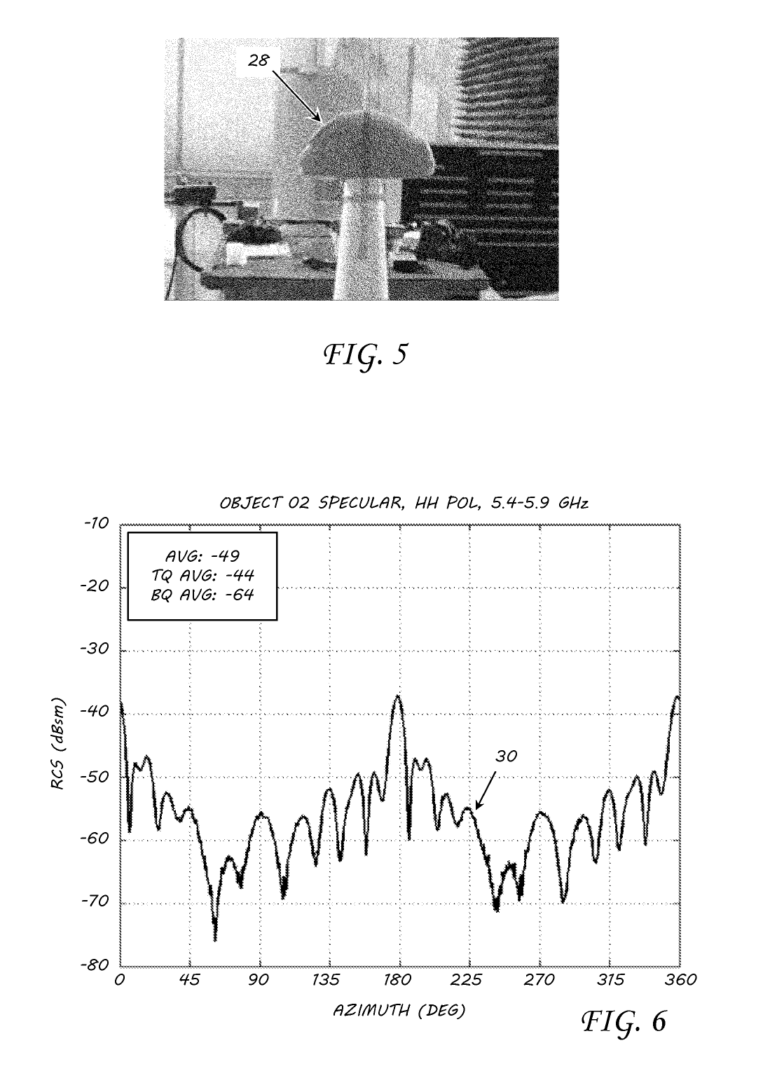

Several types of actual SSV 10 debris were measured in an indoor compact radar cross-section (RCS) range. These samples included foam, frost-covered foam, ice, ablator, ceramic tile, insulating blankets, gap filler, weather seal, putty repairs, and various others in order to assist in characterizing the debris. The debris samples, such as a foam object 28 in FIG. 5, were mounted statically and rotated 360° to obtain an azimuth scan of the object's RCS. The average of the top-quartile of RCS values was used to reflect a sample's average RCS as this was expected to most closely represent the signatures seen by the radar. A sample of the RCS data 30 is displayed in FIG. 6 for the foam object 28 pictured in FIG. 5.

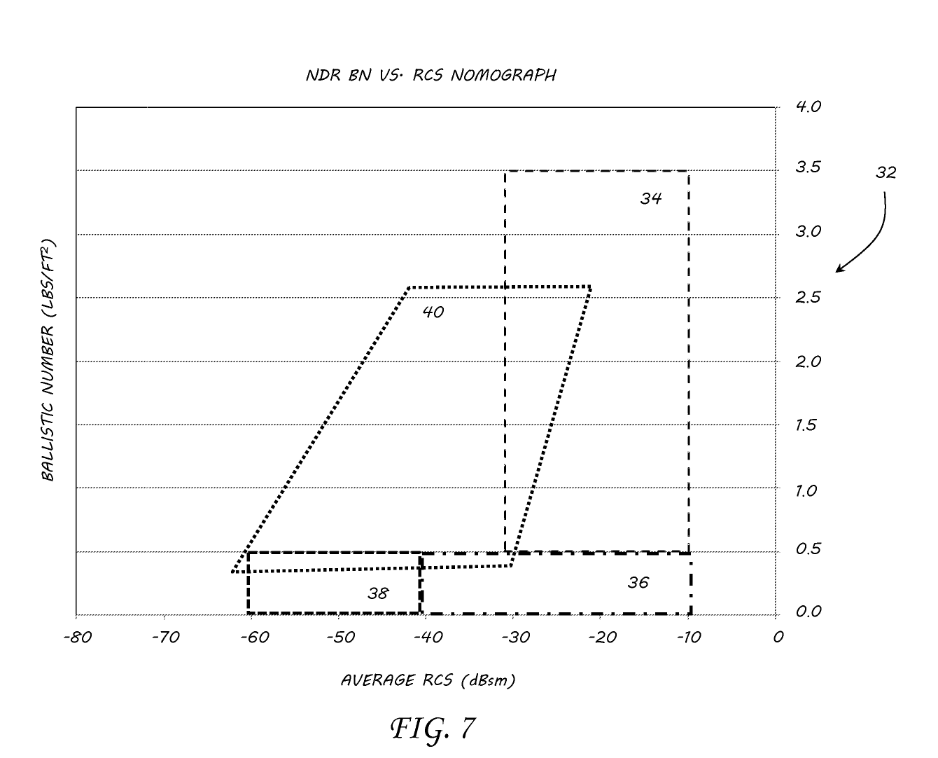

Because the RCS values varied significantly across the debris material types, it was determined that RCS may be used as a feature to assist with debris material identification in some embodiments. This feature is further strengthened when combined with the object's ballistic number (BN) which was calculated for each of the debris objects, yielding an RCS and BN value for each object. By plotting the analytically determined ballistic number versus the measured RCS, some focused regions became apparent. The four specific zones 34-40 identified from the RCS measurement data set, shown in FIG. 7, represent the following Shuttle debris categories. Zone One 34 includes all ice debris and is characterized by a wide range of ballistic numbers and includes the highest RCS values encountered during Shuttle debris missions. Zone Two 36 includes foam with ice coating, frost, and RTV gap filler material, and is characterized by low ballistic numbers with moderate to high RCS values. Zone Three 38 includes foam, ceramic gap filler, and weather seal material. This region is characterized by low ballistic numbers and the lowest RCS values typically seen for a Shuttle debris mission. Zone Four 40 includes dense ablator material, Shuttle tile, FRSI insulation, and putty repair material. This group typically catches any outliers from the other three groups, and spans a wide range of ballistic numbers and RCS values. FIG. 8 shows the top-quartile average RCS data plotted against the calculated ballistic number for all of the measured debris samples.

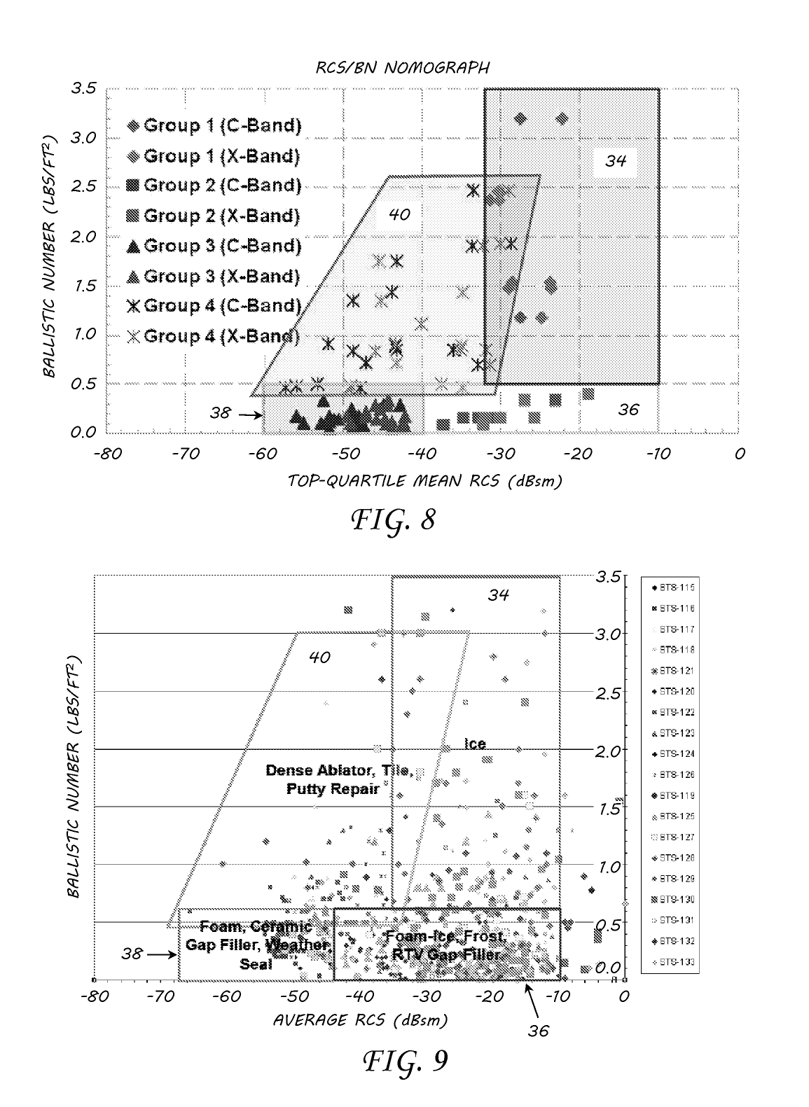

The measured RCS and assessed BN values for debris samples that were identified in NDR mission data from STS-121 (July 2006) through STS-133 (February 2011) are plotted in FIG. 9. The RCS vs BN nomograph regions that were defined using the static RCS measurements and BN calculations are also displayed, indicating the value of the RCS and BN data for determining a debris material type.

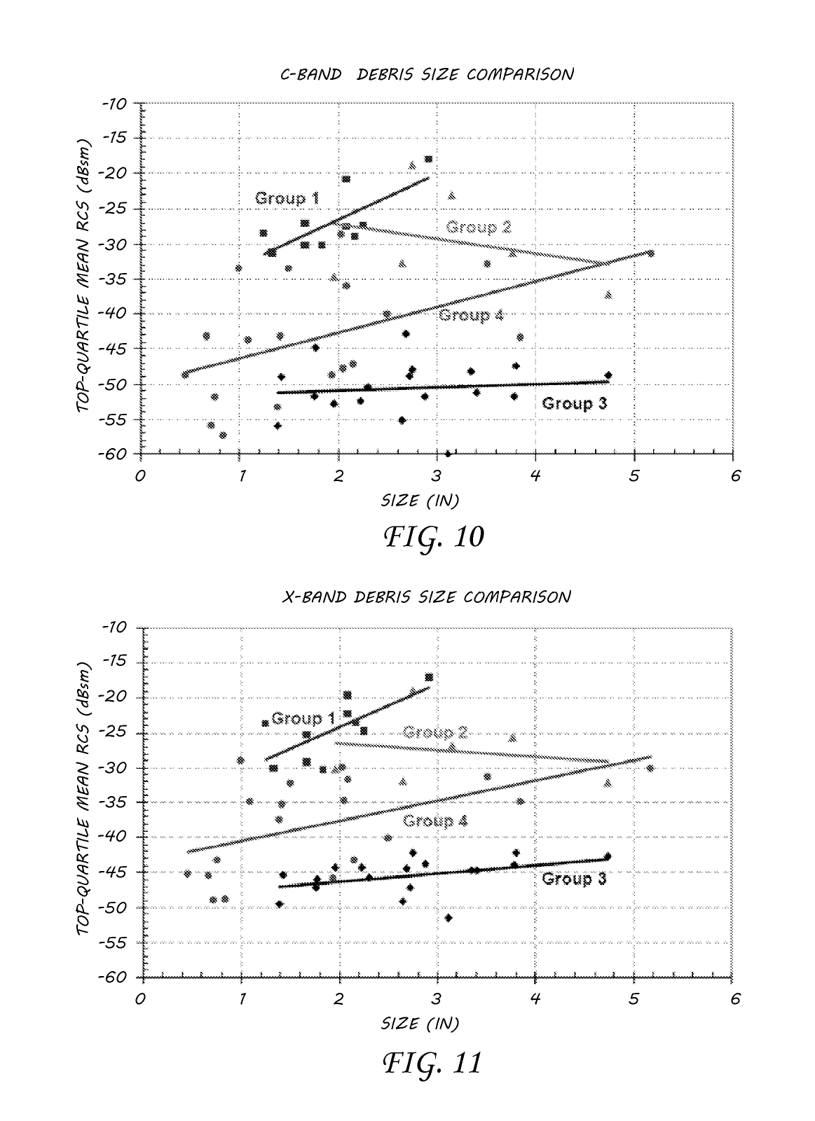

In addition to the RCS vs BN nomograph, a characteristic size was computed for each debris sample. This size was equal to the average length of the smallest bounding box that could hold the debris sample. This enabled a display of characteristic size as a function of RCS for each of the samples. A linear fit was computed through all samples of each group in order to estimate the size of debris based on its RCS value. The size estimation data is displayed in FIG. 10 for C-band and FIG. 11 for X-band with Group 1 corresponding to materials in Zone One 34, Group 2 corresponding to materials in Zone Two 36, Group 3 corresponding to materials in Zone Three 38, and Group 4 corresponding to materials in Zone Four 40. The results for Group 2 were inconclusive, as the linear fit implies that the RCS of these objects will decrease as the size increases, which is not the expected behavior. As a result, size estimates were not assessed for Group 2 objects.

To complement the static RCS measurement results of SSV 10 debris samples, dynamic RCS data not obtainable in a static test environment is needed for understanding detection criteria and debris identification. Debris separating from a high speed launch vehicle may depart with unique “flight” characteristics that would impart dynamic signature information in the radar return. Some objects may “trim out and fly” and be very stable while others might tumble erratically or exhibit uniform spin. These departure characteristics would impart modulation on the radar return that could be exploited by Doppler radar to uniquely identify various debris sources. In order to better understand what characteristics might be observed, dynamic signature measurements were obtained on a subset of the debris pieces that were measured in the indoor chamber. The pieces were released from an aircraft in flight and the signature characteristics were measured during separation and subsequent freefall to earth.

The in-flight test included 24 different pieces of actual debris, which were released from the side door of a C-130 aircraft while the RCS measurement system detected and tracked each object during separation from the aircraft and during free fall. Measured debris included various items such as tape, insulation, wire, nuts, bolts, ice, slag, etc.

Following the dynamic measurements, the data was processed for each item to analyze the RCS statistics and Doppler signatures. The RCS levels varied not only as a function of frequency but also over time as the aspect angles changed in the dynamic environment. For example, the median X-band RCS computed for the various objects ranged from the brightest object at −22 dBsm to the dimmest object at −55 dBsm, a 33 dB range. This confirmed that some of the debris could be separated by RCS amplitude when detected in flight conditions. Further, each object exhibited a spread in RCS over the observation period typically about 30 dB from minimum to maximum, but some spreads were as low as 10 dB while others approached 50 dB. Thus debris objects may be identified by RCS level variation. The dynamic data was then compared to static RCS measurements. In general, the dynamic measurement results showed the RCS levels to be lower than those obtained from the static measurement for two reasons, 1) bright specular returns requiring precise angular alignment were not observed in flight, and 2) the specular, if observed, was likely integrated with adjacent non-specular returns since the dynamic radar integrated returns across a five degree angular bin.

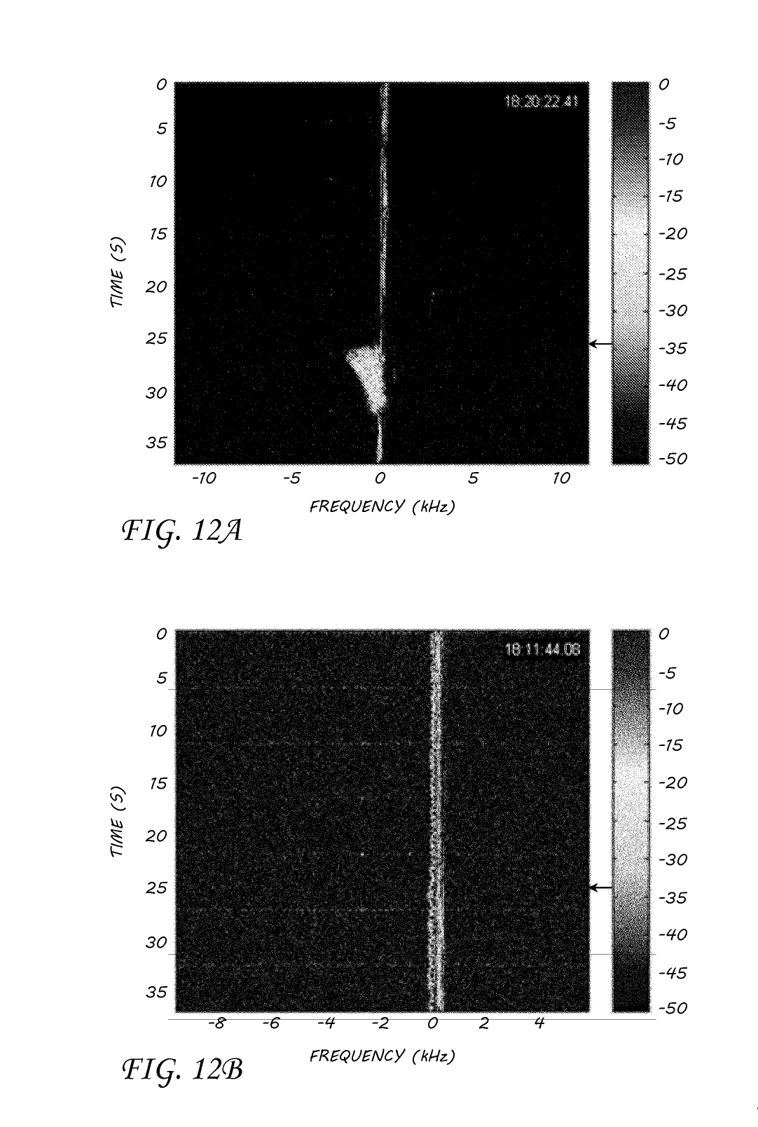

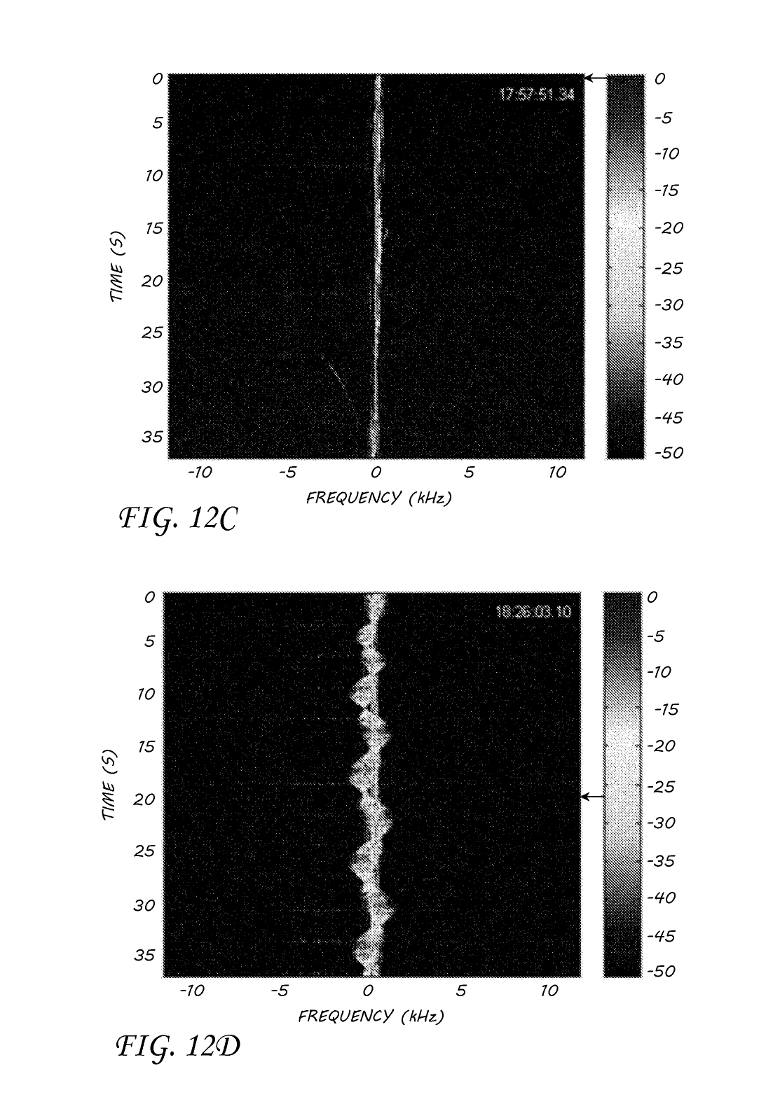

Finally, the Doppler signatures of the dispensed objects were evaluated and found to fall into one of the four groups displayed in FIGS. 12A-D. Debris items that included multiple individual pieces such as slag shower or multiple pieces of ice exhibited a very disperse frequency spread and appear “cloud like” on a Doppler Time Intensity (DTI) plot (FIG. 12A). Items such as the thermal blanket exhibited a less disperse frequency spread (FIG. 12B). A third type of signature was a distinct return with very little frequency dispersion and with or without an “on/off” blinking return typically generated by hardware items with low aspect variations such as the connector nut (FIG. 12C). A fourth signature type, a periodic frequency modulation characteristic or spinning appearance on a DTI plot, was produced by objects with significant tumble variation such as the kick ring splice cover (FIG. 12D). Overall, the dynamic signature measurements provided critical insight into the dynamic signature characteristics of the various debris items. The measurements also assisted in understanding how to use the static measured RCS levels to better represent the dynamic RCS performance of an object.

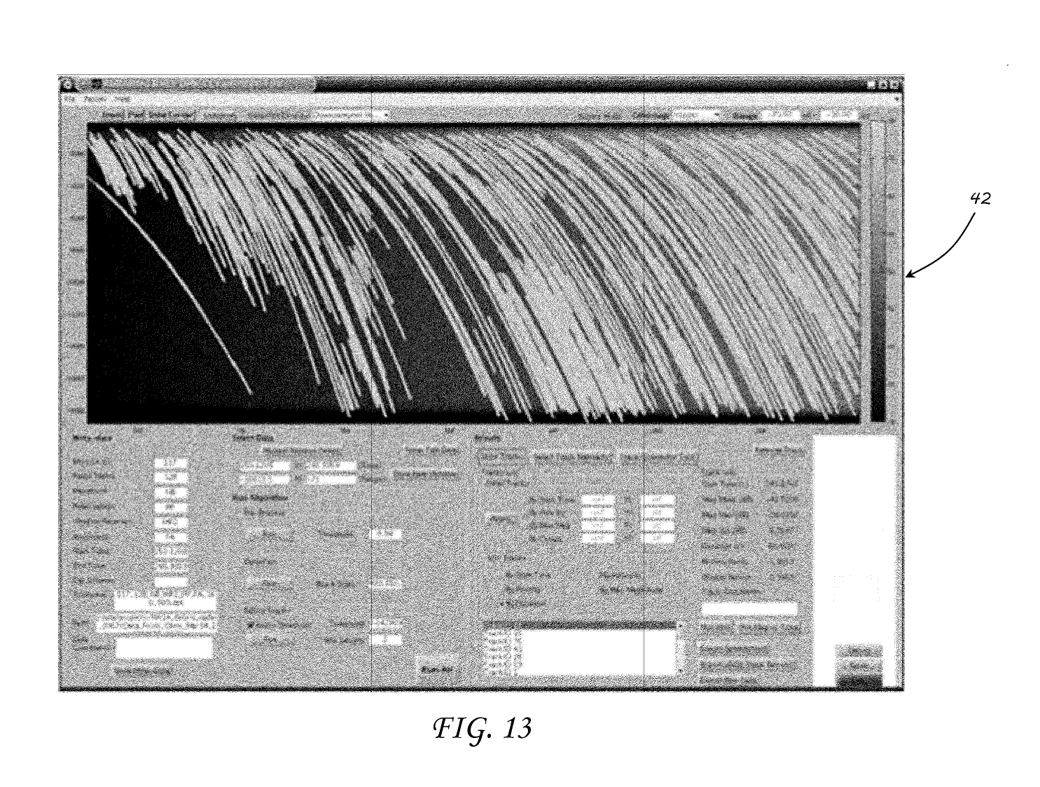

The maturation of the debris detection and characterization processes led to development of algorithms to automate debris detection and characterization. One such tool implementing these algorithms, Ascent Radar Debris Examination Tool (ARDENT), was designed to automatically detect and characterize shuttle debris observed by the C-band radar during the SSV late ascent timeframe (>150 seconds after launch), due to the large amount of debris released during this timeframe. For example, FIG. 13 demonstrates the detection performance 42 using data collected during an SSV 10 ascent from 150 to 300 seconds after launch. The debris present in this timeframe is generally referred to as the late ascent shower, and is a known and expected debris event due to foam release from the external tank. The nature of the debris released in this timeframe, referred to as “popcorn foam,” was an expected condition created by the combination of heat soak from aero friction into the foam combined with a deepening vacuum caused by exo-atmospheric flight. While the presence of this debris was expected, the high frequency—several per second—and duration, from approximately 105 seconds to Loss of Signal (LOS) at the far horizon, was far too high for manual and traditional analysis techniques. Also, while the threat from popcorn foam was low, its presence masked other potentially more threatening and unexpected debris events during this timeframe. This required a software tool to automatically parse the data and assess the threat of the events observed by the radar.

The ARDENT debris detection algorithm uses a Multi-Scale Localized Radon Transform (MSLRT) optimized for this application. The MSLRT computes a localized Radon transform of blocks of the data for multiple block sizes (or scales) to form an aggregated (across scales) debris track detection map based on identifying piecewise linear features in the data. From this detection map, a track refinement process forms individual debris tracks that are then characterized and stored for analysis and reporting. The ARDENT tool enables users to visualize the radar data, enter and modify meta data, adjust the debris detection algorithm settings, select and modify tracks, and display various results including histograms of track and RCS statistics and RCS plots for individual tracks.

ARDENT is generally used to characterize the debris environment after 150 seconds, when the release frequency is higher and yet the unexpected release hazard is generally lower than during flight through the denser lower atmosphere. However, additional tools are needed to analyze and characterize the debris environment from launch to 150 seconds, which is when the highest threat of damage to the launch vehicle may occur.

An application was developed, for embodiments of the invention, to analyze data within the first 150 seconds of flight. The application, referred to as the Debris application, consolidates and extends the capability of several discrete applications that were developed early in the NDR analysis maturation process. Specific applications include tools for viewing the NDR radar data, annotating potential debris object tracks in the data, assessing the trajectory of the object, computing radar cross-section (RCS) statistics of the object, assessing the BN of the debris, and storing the debris characteristics in a mission-specific database structure. The consolidation of these capabilities into a single, unified data processing analysis tool assist in streamlining the analysis process and reduces the time, effort and manpower required to characterize the ascent debris and potential risk to any rocket-propelled launch vehicle.

The Debris application utilized by embodiments of the invention allows a user to visualize and explore the data collected by the three NDR systems and annotate observed debris objects and their motion relative to the radar. It also allows ballistic analysis of a debris object, and allows the user to display the annotated events from all contributing sensors and their associated ballistic and radar signature properties. The user begins by loading radar data that is of interest for debris analysis. The application displays the data and provides the user with various methods to vary the zoom, pan, color map, and adjust data range settings. These various settings are useful to detect objects that are visible just above the noise floor of the radar data. Once an object of interest has been identified, the user may create a region of interest and annotate the object in the radar data. The application provides several metrics to assess the confidence that the track is indeed a physical object and not just a fortuitous collection of noise pixels that appear to represent a real object. One example of these metrics is a Kolmogorov-Smirnov (K-S) statistic which provides a metric of how well the identified object matches the local noise. If the object is assessed as a poor fit with the local noise statistics the metric builds confidence that the trace is a real object.

Following the detection of possible debris objects, a separate trajectory analysis utilizes day-of-launch inputs, such as weather, launch time, vehicle trajectory, and radar position, to develop a free-stream ballistic debris trajectory model of each object. A trajectory analyst matches the annotated track to that which would be observed by a debris object with known mass and Mach number. Trajectory-related output products include ballistic number, track length (in time and distance), and velocity distribution relative to shuttle velocity. Extremely low initial shuttle-relative velocities indicate that the object is observed at or shortly after release from the vehicle. Objects with an initial observation at higher relative velocities or those observed behind the vehicle can be back-propagated to the vehicle to assess the release time and location. The Debris application retains all of the RCS and trajectory information that is used to assess the size, shape and material type of debris objects and permits iterative assessments of the objects. All of this information is utilized to develop actionable assessments of the ascent debris environment and threat to the safety of the shuttle vehicle and crew.

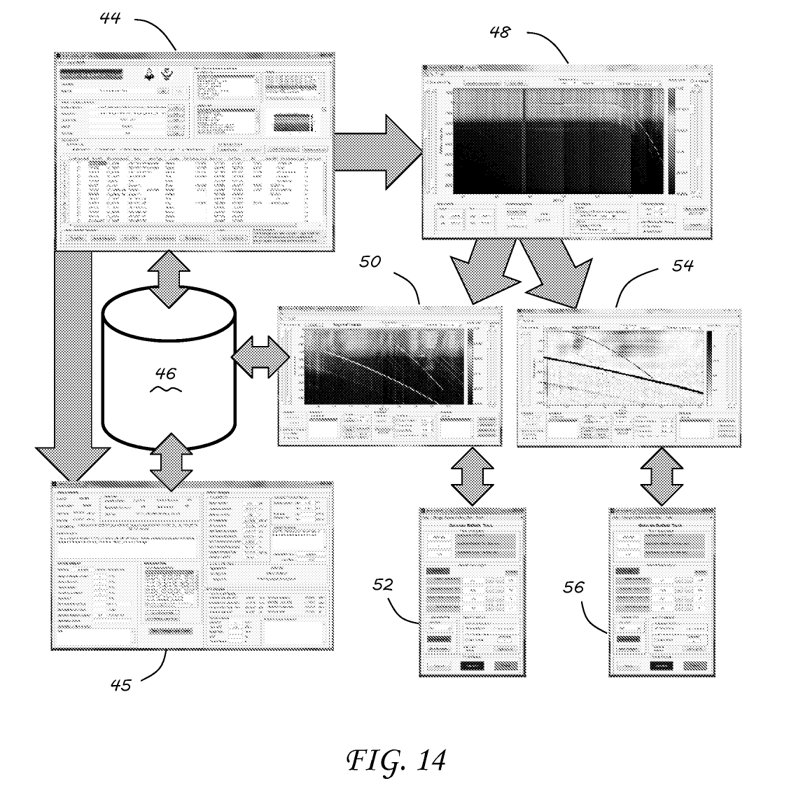

A user begins work in a graphical user interface (Master GUI) (block 44) illustrated in FIG. 14, where mission data such as the weather, vehicle trajectory, and launch time are specified. The user can also view summary information about all identified debris events and open an Event Information GUI (block 45) to view all information collected pertaining to a given event, which is stored in a series of files in an organized directory structure on network storage (block 46). Also in the Mater GUI, the user selects radar data files to be opened for viewing in a Data Viewer GUI (block 48). In the Data Viewer GUI the user analyzes the radar data to find debris events. A variety of display options are available to aid the analyst in finding the often weak debris signatures. One particularly useful feature is a data transformation referred to as Normalized Noise which performs an adaptive scaling of the data that aims to force the statistical distribution of the noise to be constant across the data. The scaling tends to bring out weaker signals which greatly aides the user in identifying faint debris events. Once one or more debris events are identified in a particular segment of radar data, the user instantiates one or more Region of Interest (ROI) GUIs (blocks 50,54) where the user annotates the observed events and can perform ballistic analysis via the Ballistic Analysis GUI (blocks 52,56).

After analysis, post-processing of the data may take a number of forms in different embodiments of the invention. For example, the RCS vs BN nomograph in FIG. 7 may be utilized for assisting with debris material determination. Once the RCS and BN have been estimated, these values can be compared to the regions in the nomograph to determine likely type of material (Group 1-4). These nomographs have been constructed utilizing a series of controlled indoor and outdoor measurements as discussed above. Other nomographs, such as those in FIGS. 10 and 11, may be used to assess the potential characteristic size of the debris based on its RCS and Group assessment.

Additional post processing, for some embodiments, may employ a Fusion Tool, which was developed to provide visualization and analysis capabilities in support of various NDR missions. The Fusion Tool utilizes a 3-D digital terrain model and is capable of displaying the SSV trajectory including separation events. The locations of the ground and ship-based NDR systems are included and the radar pointing angles can be displayed during the shuttle flyout. Mission data is recorded and can be played back post-mission in support of debris analysis. Also, several geometric distance and angle calculations can be performed to support the analysis mission.

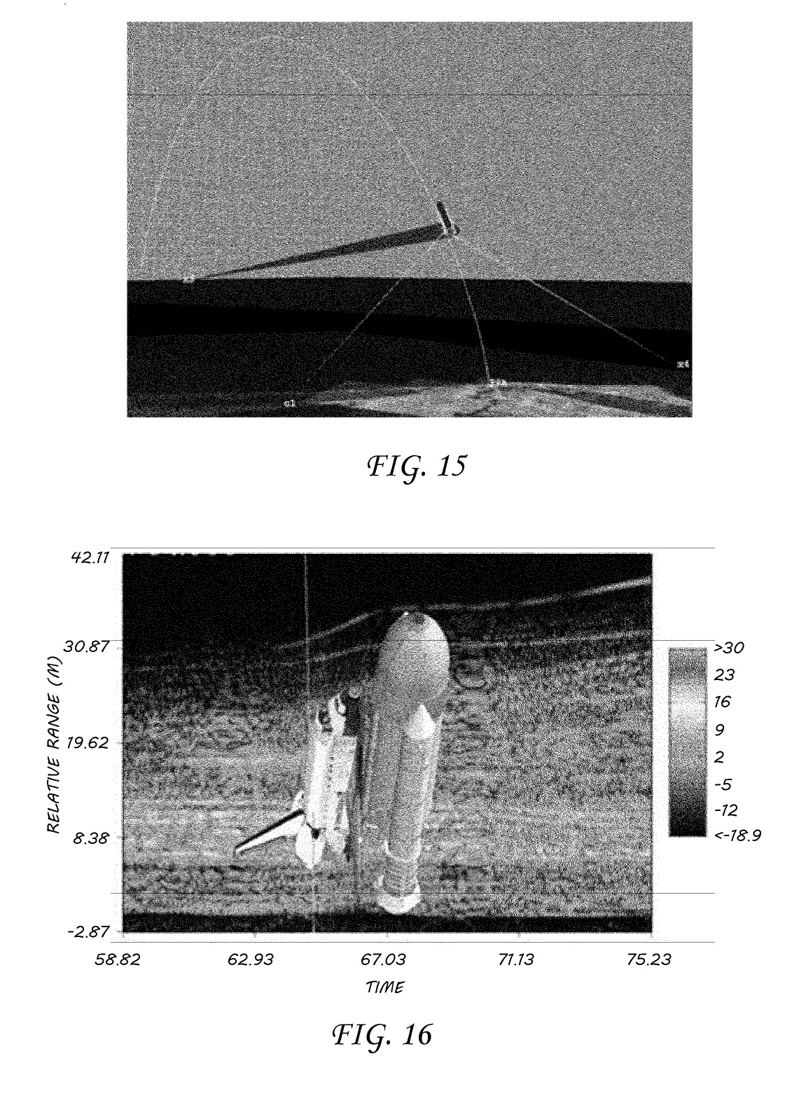

The Fusion Tool displays, in some embodiments, real-time shuttle trajectory (via the Eastern Range's integrated trajectory solution) and the pointing angles of the three NDR systems as illustrated in FIG. 15. The displays may be used by radar operators and managers in the NDR Operations Center.

Following a mission, the Fusion Tool may be used for mission playback and in support of the analysis phase by knowing the relative position of the SSV, the NDR systems, and debris objects as a function of time. The SSV position may be overlaid on radar data (FIG. 16) to assist in estimating the release location of debris, which is an important piece of information for debris threat assessment. Thus, this tool is integrated into embodiments of the invention to assist in visualizing the debris events identified by the Debris application above.

From the above analyses, a threat analysis may be performed in some embodiments, where debris events may be classified as reportable, significant, or not applicable. Reportable events are those that are fully analyzed and submitted into an imagery reporting database. Significant events are documented and analyzed but do not meet the reportable criteria. Not applicable events are determined as low threat during the analysis process. The reportable criterion includes a piece of debris that originates within the vehicle stack and potentially exceeds an allowable debris size, is seen to have interfered with or impacted the vehicle, or is seen to have an unexplained Doppler or radar shift. Additional criterion may include: an indication of a secondary debris event that is caused by an observed debris piece, an event that potentially correlates with a reportable item from another sensor, and unusual observations deemed significant by the radar debris analysis team. Debris parameters that are considered during the threat analysis include: release time, release location (forward, mid, aft), debris velocity, radar cross section (RCS), ballistic number (BN), debris material type and size.

Additional reports may also be generated. These reports may contain summaries of radar track quality, tables containing reportable debris descriptions and technical parameters, debris event summary descriptions for each reportable debris item, histograms of debris items as a function of flight time, comparisons of debris environment to historical averages, solid rocket booster analysis, post-launch weather scan, and other mission specific items of interest. However, these reports need to be produced quickly in the event of an early mission termination, prior to the space shuttle thermal protection system (TPS) being cleared for nominal entry. By better understanding the ascent debris environment, mission managers would be better able to assess the threat to the returning vehicle and crew. Summaries and threat analyses are generally delivered to the program within three days of launch.

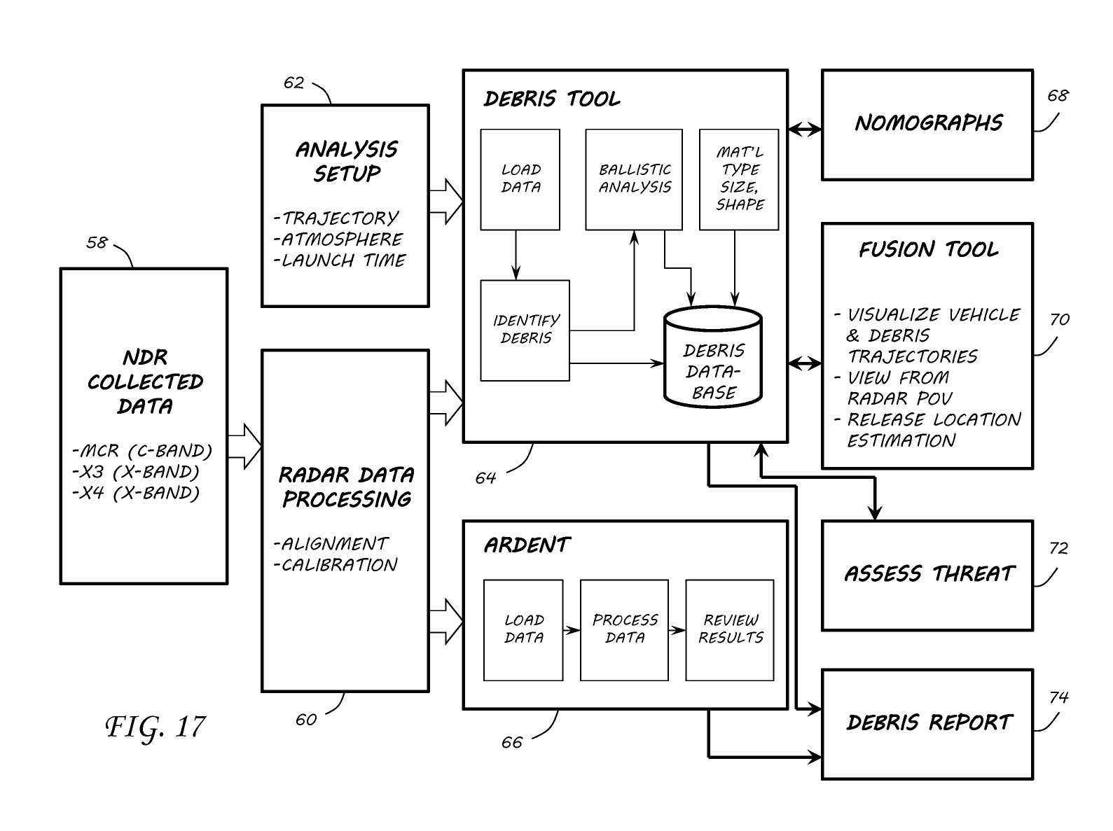

To assist in turning around the analysis, embodiments of the invention incorporate all of the above tools into a single system and methodology illustrated in FIG. 17. This system has been developed primarily for Space Shuttle Vehicle launches, but has also been applied to Expendable Launch Vehicles (ELVs). The initial step involves collecting the C-band and X-band radar data in block 58. This step requires that all of the sensors are in place and configured to collected data at launch time. A complex synchronization of radar transmission is performed with the USAF's Eastern Range to ensure that the NDR systems do not transmit the same time as other radars that are tracking the space vehicle. This is accomplished by assignment of a time slot for each radar system that will collect data during launch. The NDR systems track the vehicle and collect data until the track is lost, which is typically when the vehicle is lost over the line of sight horizon, which can be up to 500 seconds after launch. Several types of data are simultaneously collected with the C-band radar, including two different bandwidths (narrowband/8 MHz vs wideband/500 MHz), two polarizations (right-left circular vs right-right circular), and two window receiver locations (centered on SSV vs trailing the SSV). The raw data is parsed into 150 seconds per file, which results in a total of 48 C-band data files to be analyzed, each of which may be upwards of 650 megabytes or larger. Following the data collection, the raw data is processed for range alignment and amplitude calibration in block 60. Vehicle trajectory, atmospheric conditions, and the exact launch time (block 62) are provided to the Debris application. The processed radar data is passed in parallel to the Debris application (block 64) for analysis from launch time to 150 seconds and to ARDENT (block 66) for analysis from 150 seconds until loss of signal. It is at this point in the process, utilizing the Debris application and ARDENT, that debris objects are identified in the NDR data. Once a potential object is found, the Debris application allows the user to trace the path of the debris by using an annotation feature. The tool then provides statistics to assess the confidence that this object is actually a piece of debris and not a random collection of bright noise pixels. RCS metrics are also computed, such as peak RCS, average RCS, and tumble period if the object displays a blinking amplitude fluctuation over time. Based on these statistics, the user can elect to enter this object into the debris database within the Debris application and an object number is automatically assigned. The Debris application is then used to assess the ballistic number of the object and that information is also stored in the application's database.

In parallel with the Debris application analysis, the ARDENT software is used to automatically detect and characterize debris in the data collected later than 150 seconds after launch. The ARDENT results are reviewed for abnormal debris results, such as separating objects with an unusually high RCS or BN value, indicating an abnormally large debris item. Following the identification of debris objects using the Debris application and ARDENT, the RCS vs BN nomographs (block 68) are used to assess debris material type based on the location of the object in one of the four regions and the assessed material type is entered into the Debris application database. The RCS, BN, and nomograph information is combined with knowledge of the SSV and its launch profile to estimate the material type of the debris. For instance, it is impossible for release of a debris material associated only with the solid rocket booster (SRB) after 130 seconds, since the SRBs have already separated from the orbiter and external tank. Another important piece of information is the potential size of a debris object since a larger, heavier object can cause more damage to the orbiter than a smaller, lighter one. Once the RCS statistics and material type have been estimated, the RCS vs Size nomograph is used to assess the possible characteristic size of the debris object (with the exception of Group 2 objects). The size is then entered into the Debris application database.

The fusion tool (block 70) is used throughout the analysis to visualize various aspects of the shuttle and debris trajectories relative to each other. The debris trajectory, BN estimate, and the fusion tool are collectively used to attempt to determine the possible release location of the debris from the SSV system. Objects released “higher” forward on the SSV pose a much higher threat than those released at the aft end due to the potential to interact with and damage the orbiter and its TPS system. The SSV system is broken into thirds (forward, mid, and aft) and an attempt is made to assess from which third the object originated. The Threat assessments (block 72) are an objective of this analysis process, and objects are assessed as either Reportable, Significant, or Not Applicable. Reportable items are communicated to the Space Shuttle Program along with any derived information that can help determine the damage and threat potential. Corroboration with other sensors (cameras, video, impact accelerometers on wing leading edges, etc.) occurs as reports are submitted to the NASA debris analysis teams. Finally, a debris report (block 74) is generated based on the overall NDR evaluation effort. The final report contains any information derived on reportable debris objects that may be useful for threat assessment. The parallel processing of the radar data enabled by the Debris application, ARDENT, and the overall debris analysis process enables the assessment and reporting of the NDR data to be delivered to the program in a matter of days.

Based on the vast amount of data collected during launch, a computer is utilized for processing of the radar data and portions of the debris identification as well as for visualization and post processing of the data. FIG. 18 illustrates an exemplary hardware and software environment for an apparatus 76 suitable for performing debris analysis in a manner consistent with the invention. For the purposes of the invention, apparatus 76 may represent practically any computer, computer system, or programmable device, e.g., multi-user or single-user computers, desktop computers, portable computers and devices, handheld devices, network devices, mobile phones, etc. Apparatus 76 will hereinafter be referred to as a “computer” although it should be appreciated that the term “apparatus” may also include other suitable programmable electronic devices.

Computer 76 typically includes at least one processor 78 coupled to a memory 80. Processor 78 may represent one or more processors (e.g. microprocessors), and memory 80 may represent the random access memory (RAM) devices comprising the main storage of computer 76, as well as any supplemental levels of memory, e.g., cache memories, non-volatile or backup memories (e.g. programmable or flash memories), read-only memories, etc. In addition, memory 80 may be considered to include memory storage physically located elsewhere in computer 76, e.g., any cache memory in a processor 78, as well as any storage capacity used as a virtual memory, e.g., as stored on a mass storage device 82 or another computer coupled to computer 76 via a network 84. The mass storage device 82 may contain a cache or other dataspace 86 which may include databases 88a and 88b.

Computer 76 also typically receives a number of inputs and outputs for communicating information externally. For interface with a user or operator, computer 76 typically includes one or more user input devices 90 (e.g., a keyboard, a mouse, a trackball, a joystick, a touchpad, a keypad, a stylus, and/or a microphone, among others). Computer 76 may also include a display 92 (e.g., a CRT monitor, an LCD display panel, and/or a speaker, among others). The interface to computer 76 may also be through an external terminal (not shown) connected directly or remotely to computer 76, or through another computer communicating with computer 76 via a network 84, modem, or other type of communications device.

Computer 76 operates under the control of an operating system 94, and executes or otherwise relies upon various computer software applications, components, programs, objects, modules, data structures, etc. (e.g. Debris analysis tool 96 and ARDENT tool 98). The Debris analysis tool 96, for example, may analyze debris events in the first 150 seconds after launch while the ARDENT tool 98 performs, in parallel, analysis on debris events after 150 seconds, each potentially storing event data on databases, such as the database 88a, 88b in the dataspace 86. Computer 76 communicates on the network 84 through a network interface 100.

In general, the routines executed to implement the embodiments of the invention, whether implemented as part of an operating system or a specific application, component, program, object, module or sequence of instructions will be referred to herein as “computer program code”, or simply “program code”. The computer program code typically comprises one or more instructions that are resident at various times in various memory and storage devices in a computer, and that, when read and executed by one or more processors in a computer, causes that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to physical, recordable type media such as volatile and non-volatile memory devices, floppy and other removable disks, hard disk drives, optical disks (e.g., CD-ROM's, DVD's, etc.), among others, and transmission type media such as digital and analog communication links.

In addition, various program code described hereinafter may be identified based upon the application or software component within which it is implemented in specific embodiments of the invention. However, it should be appreciated that any particular program nomenclature that follows is merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

Those skilled in the art will recognize that the exemplary environment illustrated in FIG. 18 is not intended to limit the present invention. Indeed, those skilled in the art will recognize that other alternative hardware and/or software environments may be used without departing from the scope of the invention.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. For example, initial shuttle missions, beginning with the STS-114 return to flight launch, were supported by a debris radar team using large paper plots of the radar data requiring several people to simultaneously look over and review the data for possible debris events. As possible debris object were identified and drawn on the paper, the paper was given to other analysts to process discretely in several independent functions, one at a time. While this process was effective in determining the desired parameters of the ascent debris, it was terribly inefficient for analyzing such a large set of a data. Meeting analysis timeline requirements on the order of days after launch was very challenging using such primitive—although accepted state-of-the-art at the time—analysis tools and processes, which were prone to human error and potential missed debris events. The tools and methodology claimed in the embodiments of the invention allow for up to four times as much data to be more accurately analyzed by one quarter of the personnel required by earlier methods.

The invention in its broader aspects is therefore not limited to the specific details, representative apparatus and method, and illustrative examples shown and described. Accordingly, departures may be made from such details without departing from the scope of the general inventive concept.

What is claimed is:

1. A method of analyzing debris events after a launch of a rocket-propelled vehicle, the method comprising:
collecting radar and Doppler data of the launch of the rocket-propelled vehicle for a period of time;
determining atmospheric conditions at the time of the launch;
determining a trajectory of the rocket-propelled vehicle during ascent;
aligning and calibrating the collected radar and Doppler data;
processing a first portion of the collected radar and Doppler data with a first means for assessing and characterizing debris;
processing, in parallel with the first portion of the collected radar and Doppler data, a second portion of the collected radar and Doppler data with a second means for assessing and characterizing debris;
identifying assessed and characterized debris that may be a threat to the rocket-propelled vehicle; and
generating reports of the identified debris.

2. The method of claim 1, further comprising:
post-processing the processed first and second portions of the collected radar and Doppler data to visualize vehicle and debris trajectories; and
estimating release locations of debris.

3. The method of claim 2, wherein the post-processing of the processed first and second portions of the collected radar and Doppler data includes a data transformation comprising:
adaptively scaling the processed first and second portions of the collected radar and Doppler data to a statistical distribution of noise to be approximately constant across the data to identify weak debris signatures.

4. The method of claim 2, wherein the post-processing of the processed first and second portions of the collected radar and Doppler data comprises:
generating nomographs from the processed first and second portions of the collected radar and Doppler data.

5. The method of claim 4, wherein the generated nomographs are selected from a group consisting of: material class via ballistic number and RCS values, ballistic number versus RCS, characteristic size versus RCS, RCS versus X-band radar, RCS versus C-Band radar and combinations thereof.

6. The method of claim 2, wherein the post-processing of the processed first and second portions of the collected radar and Doppler data comprises:
displaying on a computer display a position of a trajectory of the rocket-propelled vehicle overlaid on corresponding collected radar and Doppler data.

7. The method of claim 1, wherein the first portion of the collected radar and Doppler data spans a time from the rocket-propelled vehicle launch to approximately 150 seconds.

8. The method of claim 1, wherein the second portion of the collected radar and Doppler data spans a time after a time period of the first portion of the collected radar and Doppler data.

9. The method of claim 8, wherein the second means for assessing and characterizing debris utilizes a Multi-Scale Localized Radon Transform (MSLRT) to analyze the second portion of the collected radar and Doppler data.

10. The method of claim 1, wherein the first means for assessing and characterizing debris provides a confidence level that an assessed radar track is a physical object rather than noise that appears to represent a real object.

11. The method of claim 10, wherein the provided confidence of first means for assessing and characterizing debris is determined using metrics including a Kolmogorov-Smirnov (K-S) statistic.

12. The method of claim 1, wherein the first and second means for assessing and characterizing debris includes a calculation of a ballistic number.

13. The method of claim 1, wherein after the first means assesses and characterizes debris, the method further comprises:
analyzing a separate trajectory utilizing day-of-launch inputs to develop a free-stream ballistic debris trajectory model.

14. The method of claim 13, wherein day-of-launch inputs is selected from a group consisting of: weather, launch time, vehicle trajectory, radar position, and combinations thereof.
